(19) United States
(12) Patent Application Publication
(10) Pub. No.: US 2019/0178789 A1
(43) Pub. Date: Jun. 13, 2019

(54) DAYLIGHT HAND-LAMP FOR CHECKING PAINTED SURFACES, IN PARTICULAR IN THE FIELD OF PAINT REPAIR WORK ON MOTOR VEHICLES

(71) Applicant: SATA GmbH & Co. KG, Kornwestheim (DE)

(72) Inventors: Norbert MAIER, Allmersbach i.T. (DE); Ewald SCHMON, Grafenberg (DE); Peter DETTLAFF, Remseck (DE); Sven SCHULZE, Kornwestheim (DE)

(73) Assignee: SATA GmbH & Co. KG, Kornwestheim (DE)

(21) Appl. No.: 16/278,491

(22) Filed: Feb. 18, 2019

Related U.S. Application Data
(63) Continuation of application No. PCT/EP2017/000999, filed on Aug. 21, 2017.

(30) Foreign Application Priority Data
Aug. 19, 2016 (DE) 10 2016 009 955.0

(51) Int. Cl. G01N 21/25; G01N 21/29; G01N 21/57; F21V 9/02

(52) U.S. Cl. CPC G01N 21/255; G01N 21/29; F21Y 2115/10; F21V 9/02; G01N 2201/06153; G01N 21/57

(57) ABSTRACT

A daylight hand-lamp for checking painted surfaces, in particular in the field of paint repair work on motor vehicles. The light spectrum is formed homogenously such that at a distance of between 30 cm±0.5 cm in a spectral range having a wavelength of 400 to 700 nm, a daylight deviation average value in a central area and an inner periphery is less than 20%, or the average value of a spectral stability factor is less than 10% with respect to the beam center in the central area and inner periphery.

### FIELD OF THE INVENTION

The invention relates to a daylight hand-lamp for examining painted surfaces, in particular in the context of paint repair work on motor vehicles, wherein the daylight hand-lamp includes a light-emitting body by way of which a light beam having a light spectrum similar to daylight and high luminous intensity is generable.

### BACKGROUND

In a number of painting works, a visual examination of painted surfaces is required. This is true in particular in the case of paint repair work of motor vehicles. For example, visual color comparison of the newly painted regions to original surface regions is required, because, despite detailed mixing specifications of color paints by the paint industry, color deviations may occur in practice. Furthermore, a visual comparison of color shade cards, color shade metal sheets or comparison metal sheets to surfaces which have already been painted is frequently performed before the painting process to determine the correct color shade for the new paint job.

In addition to examining color shades, a visual examination also serves for the ascertainment of further properties or defects of a painted surface. Examples to be mentioned are an undesired clouding, cratering, pinholes, orange peel effect, fish eye, sparkles, metallics or variations in the layer thickness etc.

In addition, it should be noted in the case of paint repair work on motor vehicles that the painted vehicle will be assessed or received later by the customer outside under natural light. For this reason, an examination of painted surfaces on motor vehicles by the painter must be performed outside under natural daylight. However, since paint work in particular on motor vehicles is performed in closed spaces (paint booths) for environmental reasons and to shield the painting process, there is a requirement to perform at least a preliminary examination of the painted surface immediately in the paint or workshop region. An examination in closed spaces and under artificial light additionally has the advantage that it may be performed under constant, reproducible (light) conditions. The light conditions outside, by contrast, vary due to different influence factors (weather, time of day, season, etc.).

For this reason, daylight hand-lamps have been developed which can generate light that is as similar as possible to daylight and has a relatively high luminous intensity, so that a determinative assessment of painted surfaces can be performed. After completion of the painting procedure, the painter can illuminate the painted surface using the hand-lamp, examine the result of their work, and possibly undertake corrections.

DE 10 2014 018 940 A1 discloses such a daylight hand-lamp for examining painted surfaces in the motor vehicle repair field, which is characterized by a light spectrum that is similar to daylight with high luminous intensity. When performing an examination using such a hand-lamp, a multiplicity of painting defects may be determined. Despite the high luminous intensity, some defects, color shade differences etc. cannot be detected, or be detected only with difficulty, under artificial light of a prior-art hand-lamp.

### SUMMARY

One aspect of the disclosure relates to a daylight hand-lamp for examining painted surfaces, which daylight hand-lamp can be used to make easier, or improve, the detectability of color shade differences or defects on painted surfaces when performing examinations under the artificial light of the daylight hand-lamp.

In an exemplary embodiment, the daylight hand-lamp according to the invention has a light-emitting body, by way of which a light beam, or bundle of light rays, is generable which forms a beam cross-sectional area which extends perpendicularly to a beam axis at a distance of 30 cm±0.5 cm from the light-emitting body along the beam axis.

The distance of 30 cm±0.5 cm from the light-emitting body is used because this is a distance which lies within the distance region in which a painter typically guides a hand-lamp over the surface to be examined. The properties of the above-defined beam cross-sectional area thus correspond to a reference light spot that is produced on a planar surface when the daylight hand-lamp according to the invention is arranged such that a distance d of the light-emitting body above the surface is approximately 30 cm. The lamp is here oriented such that the light beam has normal incidence on the surface.

It is to be understood that in practical use, the hand-lamp can be held relative to the surface to be examined such that the light beam strikes the surfaces at any desired angle. For example, radiation at an angle is preferred when examining metallics, sparkle etc.

The distance of 30 cm±0.5 cm is based on the outer surface of the last optical element of the light-emitting body through which the light beam travels before it leaves the hand-lamp. For example, this may be a thin cover plate of the light-emitting body.

The beam cross-sectional area or reference light spot thus defined has at least one central core region having an inside diameter of at least 16 cm. Within the core region, the light of the daylight hand-lamp according to the invention has a general color rendition index value (CRI value) of greater than 95. In addition, the illuminance in the entire core region is greater than 5000 lx. Consequently, the daylight hand-lamp can be used to produce, at a distance of 30 cm, a bright light spot with a light spectrum that is similar to daylight and additionally has a sufficient dimension (>>16 cm). These are important conditions for being able to use the daylight hand-lamp for a dependable and determinative optical examination of painted surfaces.

However, the invention is based on the finding that a significant improvement in the detectability of painting defects occurs when optimizing the properties of the produced light in a manner according to the invention in an inner peripheral region which directly surrounds the core region. The illuminance in the inner peripheral region already decreases to 1000 lx. Consequently, the inner peripheral region is defined to be the region that is situated radially between the core region and the region in which illuminance falls to below 1000 lx. The inner peripheral region is consequently surrounded by an outer peripheral region, in which the illuminance drops toward the outer boundary of the beam cross-sectional area or of the light spot.

Decisive for the daylight hand-lamp according to the invention with surprisingly good properties for checking painted surfaces is that the light spectrum across the beam cross-sectional area is homogeneous at least such that, in a spectral range with a wavelength from 400 to 700 nm, a daylight deviation mean in the core and inner peripheral regions is less than 20%.

Alternatively or in addition, the light spectrum across the beam cross-sectional area is homogeneous at least such that, in a spectral range with a wavelength of 400 to 700 nm, the mean of a spectral stability factor with respect to the beam center in the core and inner peripheral regions is less than 10%.

The range of the spectral region between a wavelength of 400 to 700 nm are a result of the finding that the light of this spectral range substantially influences the color impression of the paint surfaces.

The daylight deviation mean and the spectral stability factor with respect to the core region center are values which, in contrast for example to the general color rendition index Ra, are particularly suitable when checking painted surfaces for quantifying the homogeneity of the light impression, in particular color impression. This range is the spectral range which is substantially perceivable by the eye.

It is known that the general color rendition index Ra (CRI) represents a characteristic number that describes the quality of the color rendition of light sources of the same correlated color temperature. For the general color rendition index, the values of the first eight test colors as per DIN 6169 are included. The general color rendition index is not well suited for describing a color shade shift of one and the same light source within a light spot in particular due to the fact that differences or changes in individual test colors can compensate one another and for that reason the general color rendition index hardly changes despite a visually perceivable color shade change.

The illuminance has already greatly decreased in the inner peripheral region. For this reason, it might be assumed that this low-light peripheral region has no great influence on the validity of visual checking results. However, it has been shown that, due to the nature of the human eye, the light properties of the inner peripheral region have, against expectations, a strong influence on the visual perceivability of optical differences in the illuminated surface section. It is of primary importance that the light spectrum is embodied in a manner according to the invention so as to be homogeneous over the core region and the inner peripheral region.

The calculation of the daylight deviation mean of a location of the beam cross-sectional area is preferably performed such that a light spectrum that is normalized to the maximum intensity is ascertained at this location. The difference of the ascertained light spectrum with respect to a daylight spectrum that is normalized to the maximum intensity is then formed. Finally, the mean of the absolute differences over the spectral range of 400 to 700 nm is formed.

The calculation of the mean of the spectral stability factor with respect to the beam center of a location of the beam cross-sectional area is preferably performed such that a light spectrum that is normalized to the maximum intensity is ascertained at that location. During normalization, preferably only the maximum intensity in the visible wavelength range from 400 to 700 nm, with further preference only a wavelength range between 380 to 580 nm, is taken into account.

Next, the difference of the ascertained light spectrum with respect to a light spectrum, which is normalized to the maximum intensity and was ascertained in the beam center, is formed. Finally, the mean of the absolute differences over the spectral range from 400 to 700 nm is calculated. This mean represents the mean of the spectral stability factor.

An inside diameter of 16 cm of the bright (>5000 lx) and daylight-similar (CRI>95) core region constitutes a minimum requirement of the generable light beam. In a particularly preferred exemplary embodiment, the core region has an inside diameter of at least 20 cm, preferably 24 cm.

In a particularly preferred exemplary embodiment, the core region is configured to be even brighter and the illuminance in the core region is greater than 6000 lx, preferably greater than 7000 lx, with more preference greater than 8000 lx.

The light of the beam cross-sectional area or of the generable light spot is characterized by an even higher homogeneity if the daylight deviation mean in the core and inner peripheral regions is less than 18%, in particular less than 16%.

The same advantage can be found in an exemplary embodiment in which, alternatively or additionally, the daylight deviation mean in the core region and inner peripheral region changes by less than 6%, preferably by less than 4%. It is advantageous if the daylight deviation mean in the core and inner peripheral regions is low. However, it is also advantageous if the (low) daylight deviation mean remains relatively constant because this in turn represents a parameter of the fact that the light spectrum changes only as little as possible.

In a particularly preferred exemplary embodiment, the mean of the spectral stability factor with respect to the beam center in the core region and inner peripheral region is furthermore even less than 8%, in particular less than 6%.

In a particularly preferred exemplary embodiment, the illuminance in the inner peripheral region decreases to 500 lx, preferably to 300 lx, but the inner peripheral region here continues to meet the requirements of the homogeneity of the light spectrum.

In order to avoid undesired disturbing effects due to a non-symmetrical spot shape when checking paint products, the generable light beam has a circular cross-section. In the circumferential direction, the intensity spectrum and the light spectrum are in each case constant. The core region is circular. The inner peripheral region is formed by a ring-shaped region surrounding the circular core region. The ring-shaped inner peripheral region is adjoined in the radial direction by a ring-shaped, very low-light outer peripheral region.

In the case of a particularly preferred intensity distribution, the inner peripheral region in the radial direction has a width of greater than 4 cm, preferably greater than 6 cm, with further preference greater than 8 cm.

Consequently, it is possible, specifically due to the daylight hand-lamp, for a light spot, the core and inner peripheral region of which have a total diameter of at least 30 cm, preferably 40 cm, with further preference 50 cm, to be produced at a distance of 30 cm.

A further parameter that serves to describe the color of an artificial light is the color temperature thereof. In the case of the daylight hand-lamp in accordance with the invention, the color temperature of the light at least in the core and inner peripheral regions is preferably greater than 5500 K and/or less than 6500 K.

A suitable light-emitting means of the light-emitting body to be considered is, for example, a cost-effective halogen lamp.

In a particularly preferred exemplary embodiment, the light-emitting body comprises one or more light-emitting diodes as light-emitting means. Light-emitting diodes are characterized by low start-up times, low energy consumption and a long lifetime.

For forming the light spectrum that is similar to daylight, provision may preferably be made for at least one light-emitting diode emitting light with a light spectrum that differs from the light spectrum of a different light-emitting diode, with the result that a total spectrum that is as similar to daylight as possible is obtained due to the light spectrum superposition.

However, in a particularly preferred exemplary embodiment, the light-emitting body comprises a plurality of light-emitting diodes as light-emitting means, wherein the respective light-emitting diodes emit light with the same daylight-similar light spectrum.

One variant of the invention, in which one or more COB light-emitting diodes, or COB LEDs, are provided as light-emitting means, is characterized by a particularly compact light-emitting body.

To ensure great similarity between the light spectrum of the generable light and the daylight spectrum, a light-emitting body which comprises, as light-emitting means, one or more light-emitting diodes having a color-imparting luminescence material, preferably a phosphor-based color-imparting luminescence material, has proven useful in practice. To further improve the light spectrum, a plurality of differently colored phosphor portions can be used.

One embodiment of the invention in which a high homogeneity of the light intensity is achieved by way of the fact that the light-emitting body comprises a plurality of light-emitting diodes as light-emitting means, wherein the light-emitting diodes are each provided with a lens, is characterized by particularly good optical properties.

A particularly homogeneous intensity distribution is obtained when the light-emitting body comprises a plurality of light-emitting diodes as light-emitting means, wherein all light-emitting diodes are arranged in a plane, wherein a plurality of, in particular nine, light-emitting diodes are arranged with equal distribution on an outer circular orbit and a plurality of, in particular three, light-emitting diodes are arranged with equal distribution on an inner circular orbit.

It is advantageous for handling the daylight hand-lamp according to the invention if the daylight hand-lamp takes the form of a cable-free, battery-operated lamp. A painter can guide the hand-lamp without problems through connecting cables along the surface to be examined.

In certain applications, e.g., during the check of highly reflective or light surfaces, it is advantageous if the luminous intensity of the light-emitting body can be reduced. For this reason, the luminous intensity of the daylight hand-lamp is adjustable in a particularly preferred exemplary embodiment, at least is dimmable in the range of 50-100% of luminous intensity.

### BRIEF DESCRIPTION OF THE FIGURES

Further refinements of the invention are the subject matter of the dependent claims and of the exemplary embodiments of the invention described below. The invention will be explained in more detail below in the form of exemplary embodiments with reference to the attached figures, in which specifically:

FIG. 1 shows a side view of a daylight hand-lamp including a schematic illustration of the generable light beam,

FIG. 2 shows the beam cross-sectional area of the light beam in accordance with FIG. 1 in a schematic illustration,

FIG. 3 shows a schematic illustration of the measurement apparatus for measuring the light beam of a daylight hand-lamp,

FIG. 4 shows the illuminance of the daylight hand-lamp in accordance with FIG. 1 as a function of the distance DM from the beam center,

FIG. 5 shows the illuminance in dependence on the distance rM from the beam center in accordance with FIG. 4 only in the outer distance region,

FIG. 6 shows a comparison of the normalized light spectrum of the daylight and the normalized light spectrum of the daylight hand-lamp in accordance with FIG. 1,

FIG. 7 shows the difference of the normalized light spectra from FIG. 6,

FIG. 8 shows the daylight deviation mean of the daylight hand-lamp in accordance with FIG. 1 as a function of the distance rM from the beam center in percent,

FIG. 9 shows the mean of the spectral stability factor of the daylight hand-lamp in accordance with FIG. 1 as a function of the distance rM from the beam center in percent, and

FIG. 10 shows a front view of the head part of the daylight hand-lamp in accordance with FIG. 1.

### DETAILED DESCRIPTION

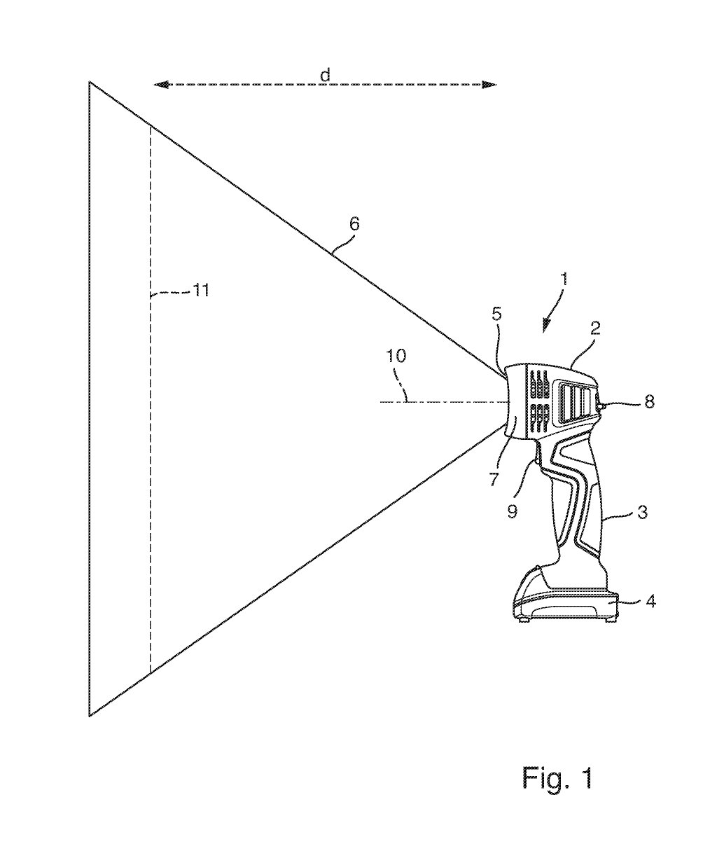

FIG. 1 shows a daylight hand-lamp 1 for checking painted surfaces, in particular as part of paint repair work on motor vehicles. The hand-lamp 1 has a head part 2, a handle part 3 and, at the lower end of the handle part 3, a releasably attached battery 4, in particular a lithium ion battery. The head part 2 has, on its front side, a light exit opening 5, through which a light beam 6 can exit. A light-emitting body 7 is arranged in the head part 2 for generating the light beam 6. FIG. 1 shows the head part 2 in the region of the light exit opening 5 in partial section so as to illustrate at least part of the light-emitting body 7.

An operating element 8, by way of which the luminous intensity of the generated light beam 6 is settable for example in a range from 50 to 100% of the maximum luminous intensity, is provided on the rear side of the head part 2. A further operating element 9 for switching the hand-lamp 1 on and off is arranged on the side facing away from the operating element 8 and below the head part 2.

FIG. 1 furthermore schematically illustrates the light beam 6 which is generable by the hand-lamp 1 and propagates along a beam axis 10. The light beam 6 forms a beam cross-sectional area 11 extending perpendicularly to the beam axis 10 at a distance d of 30 cm±0.5 cm from the light-emitting body 7. The distance is measured from the outer surface of the last optical element of the light-emitting body 7 through which the light beam 6 travels before it leaves the hand-lamp 2. In the present case, this optical element is a thin cover plate of the light-emitting body 7.

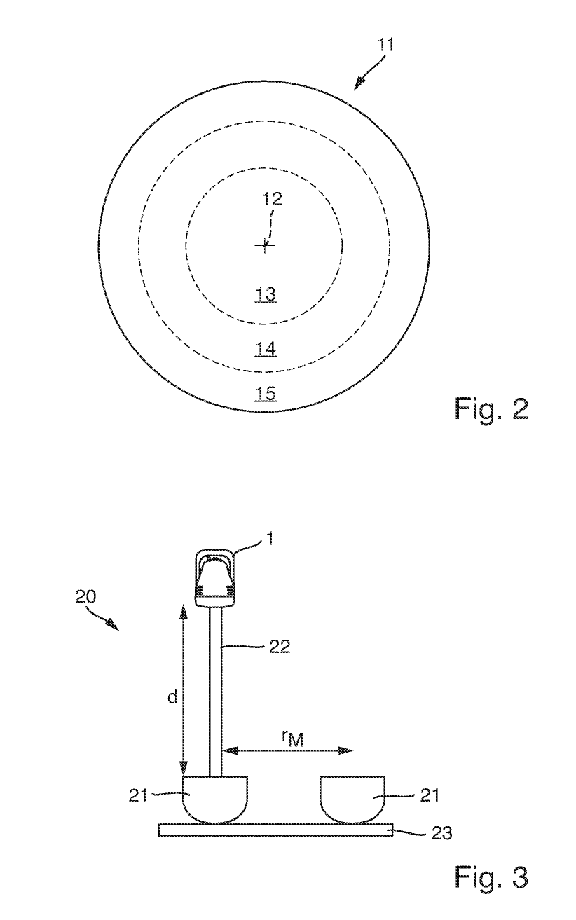

FIG. 2 shows the circular beam cross-sectional area 11 in plan view. The beam cross-sectional area 11, or the light properties thereof, correspond to the properties of a reference light spot, which is formed using the hand-lamp 1 on a planar surface when the light-emitting body 7 of the hand-lamp 1 is held at a distance of 30 cm above the surface and the light beam 6 is directed perpendicularly onto the surface.

The beam cross-sectional area 11 and the reference light spot can be divided into three regions. Starting from the beam center 12, the beam cross-sectional area 11 has a central circular core region 13, a ring-shaped inner peripheral region 14, and a ring-shaped outer peripheral region 15. The regions 13, 14, 15 are not shown strictly to scale in FIG. 2.

The central core region 13 has, for example, an inside diameter of at least 16 cm. The light at least in the core region 13 has a general color rendition index value (CRI value) of greater than 95. The illuminance in the entire core region 13 is greater than 5000 lx.

In an example of a definition of the regions, the core region 13 transitions into the inner peripheral region 14 when the illuminance falls below the value of 5000 lx. The inner peripheral region 14 in turn transitions into the very low-light outer peripheral region 15 when the illuminance has decreased to at least 1000 lx.

The color temperature of the light beam 6 is greater than 5500 K, at least in the core and inner peripheral region 13, 14.

The light generated by the hand-lamp 1 is characterized in that it is, at least in the core and inner peripheral regions 13, 14, homogeneous with respect to the light spectrum. This is clear from the fact that, in a spectral range with a wavelength of 400 to 700 nm, a daylight deviation mean in the core and inner peripheral regions 13, 14 is less than 20%.

In addition, the mean of a spectral stability factor with respect to the beam center in the core and inner peripheral regions 13, 14 is also less than 10% in the spectral range with a wavelength of 400 to 700 nm.

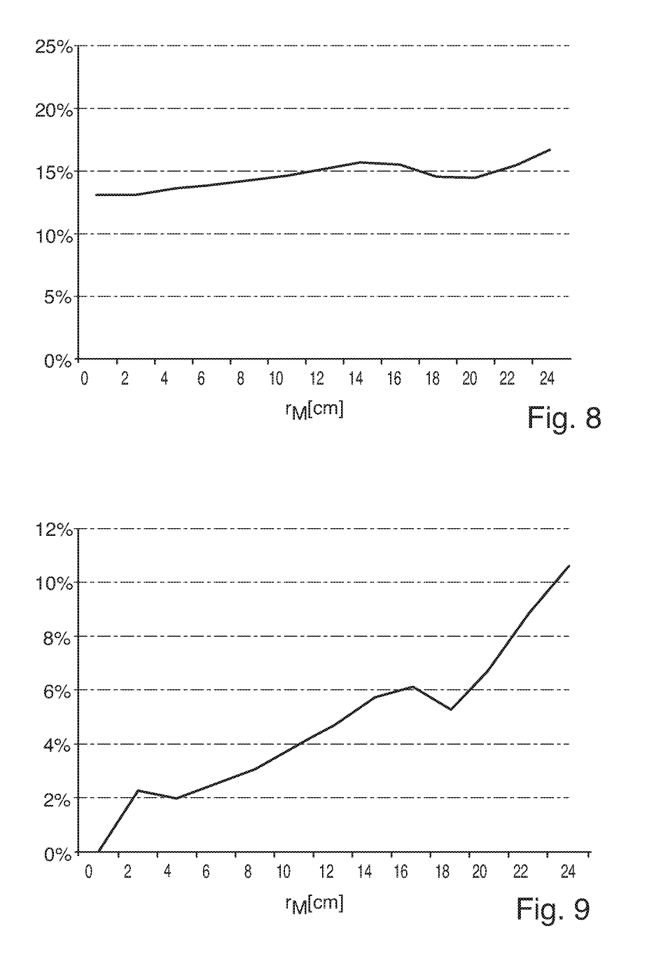

What follows is a description of how the light beam 6 of the hand-lamp 1 is measured and how finally the daylight deviation mean (FIG. 7) and the mean of the spectral stability factor with respect to the beam center 12 (FIG. 8) are ascertained from the measurement results.

FIG. 3 illustrates by way of example a measurement apparatus 20, by way of which the light properties of the hand-lamp 1 can be determined. The hand-lamp 1 is preferably attached to a stand 22 at a distance d of 30 cm above a detector 21 (specifically the lens of the detector).

The detector 21 used was a checked and calibrated spectrometer MK350S by UPRtek, having a linear CMOS image sensor (spectral bandwidth: approximately 12 nm (half bandwidth), receptor size: diameter 6.6 mm +/−0.1 mm, measurement range: 20-70 000 lx, wavelength range: 380-780 nm, integration time: 6-5000 ms).

The receptor or the measurement field of the detector 21 is shown in FIG. 3 by way of example in two positions. In the first position, the receptor is arranged centralized with respect to the center 12 of the light beam 6. In this position, the light properties in the beam center 12 are subsequently ascertained. Next, the detector 21 is radially shifted outwardly by 2 cm on the planar support surface 23. The light properties of this location of the beam cross-sectional area or of the reference light spot are ascertained. This procedure continues in 2-cm steps until a distance r_{M} of 24 cm from the center is reached, i.e., a location is measured which is situated on a circular orbit around the center 12 having a diameter of 48 cm. FIG. 3 shows, as the second position of the detector 21, a position having a distance r_{M} of 24 cm from the beam center 12 by way of example.

All measurements were performed under uniform conditions in a darkened space. The hand-lamp 1 was switched off in each case between the measurements to prevent measurement distortions caused by different switching times.

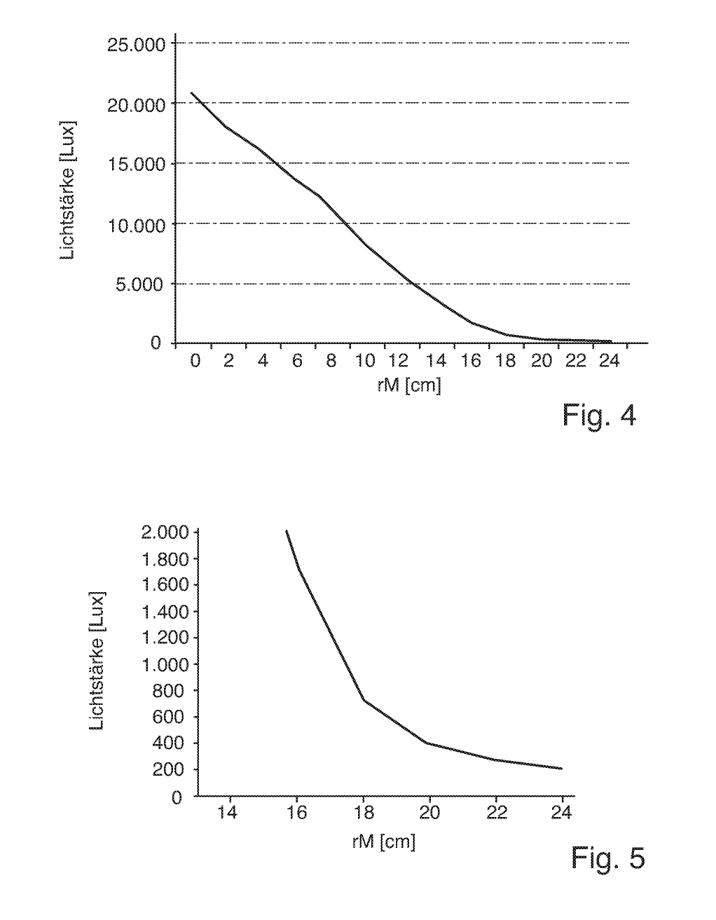

FIGS. 4 and 5 show the illuminance thus ascertained as a function of the distance r_{M} of the measurement location from the beam center 12 (r_{M}=0 cm). It is apparent that the illuminance continuously decreases outwardly from the beam center 12. It is advantageous for checking painted surfaces that the illuminance decreases gradually rather than abruptly.

It should be noted that the illuminance for a hand-lamp having light-emitting diodes as light-emitting means fades particularly gently in the peripheral region. Such gentle fading can also be obtained, for example, using a halogen lamp. However, the light of the halogen lamp in known lamps in turn has the disadvantage that the peripheral region has a different light spectrum (e.g., having a red cast). This colored corona has a disturbing effect when examining painted surfaces.

It is furthermore apparent that the illuminance in the example of the hand-lamp 1 decreases to below 5000 lx only at a distance r_{M} of approximately 12 cm. Consequently, for a definition of the core region 13 in which an illuminance of greater than 5000 lx prevails in the entire core region 13, this gives a core region 13 having an inside diameter of approximately 24 cm.

In another approach or definition of the core region 13, it can be seen from FIG. 4 that, in the example of a hand-lamp, the illuminance in a core region 13 having a diameter of 16 cm (r_{M}=8 cm) is even greater than 10 000 lx.

The hand-lamp 1 advantageously has a maximum illuminance—in the beam center 12—of more than 16 000 lx, specifically of more than 20 000 lx.

FIGS. 4 and 5 furthermore show that, for a definition in which the inner peripheral region 14 ends when the illuminance falls below 1000 lx, the inner peripheral region 14 ends at a distance rm from the beam center 12 of approximately 17 cm.

However, it is also possible to use definitions in which the inner peripheral region 14 is the region in which the illuminance decreases to 500 lx, preferably to 300 lx. In this case, the inner peripheral region 14 extends up to a distance rm of approximately 19 cm or 21 cm. Consequently, the inner peripheral region 14 can have a width of greater than 4 cm, preferably greater than 6 cm, with more preference greater than 8 cm.

To determine the daylight spectrum, measurements of the daylight were performed using the detector MK350S by UPRtek under different weather conditions, times of day and compass directions, and a daylight spectrum which is averaged over these measurements was calculated. The daylight spectrum thus calculated was compared to the values of the standard illuminant of the class D (daylight), in particular D65 (6500 K), of the CIE 1931 color space. Only slight deviations were ascertained which have no relevant influence on the parameters that are calculated on the basis of the daylight spectrum.

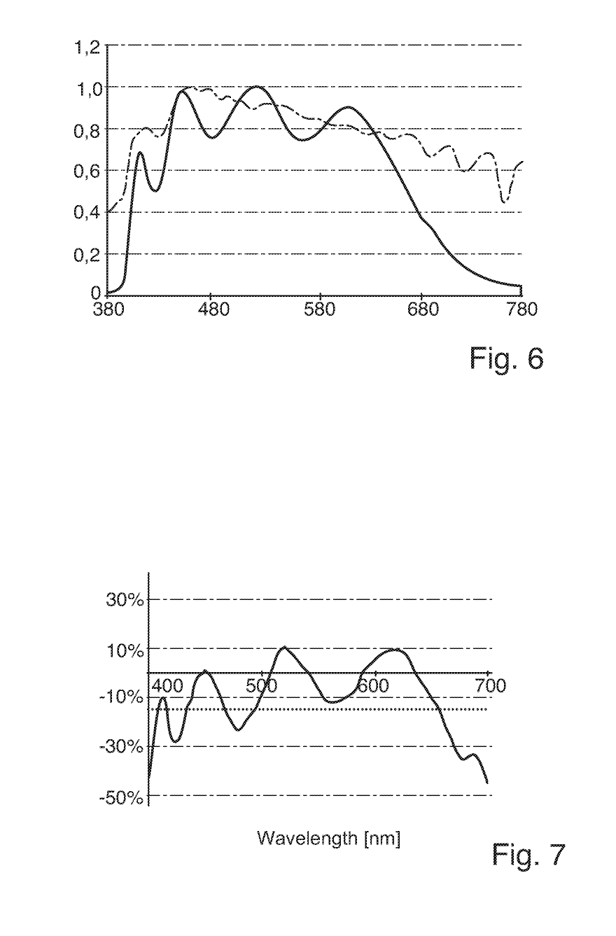

FIG. 6 shows the light spectra of the daylight and of the light beam of the hand-lamp in the beam center 12, which are respectively normalized to their maximum intensity. A good match with the daylight spectrum is apparent, which also becomes clear from the diagram shown in FIG. 7. FIG. 7 shows the difference in percent of the normalized spectra shown in FIG. 6 in the relevant range from 400 to 700 nm.

The mean over the range from 400 to 700 nm was formed based on the absolute differences shown. The result is thus the daylight deviation mean of the light beam 6 in the beam center 12 in percent. Analogously, the daylight deviation mean of the light beam 6 is ascertained in the case of the remaining measured distances rm from the beam center 12. The result can be found in FIG. 8, which shows the daylight deviation mean as a function of the distance r_{M}.

The daylight deviation mean over the entire measured distance region is less than 20%, specifically even less than 18%. Up to a distance r_{M} of approximately 22 cm, the daylight deviation mean is less than 16%.

In addition, the daylight deviation mean in the entire measured distance region varies by less than 6%, specifically by less than 4%.

As already mentioned, FIG. 9 shows the mean of a spectral stability factor with respect to the beam center 12. The spectral stability factor is determined analogously with the daylight deviation mean, but it is not the difference with respect to the normalized daylight spectrum but rather the difference with respect to the normalized light spectrum in the beam center 12 that is formed. Consequently, the mean of the spectral stability factor in the center 12 (distance r_{M}=0 cm) is zero.

The mean of the spectral stability factor with respect to the beam center 12 is less than 8% up to a distance r_{M} of approximately 20 cm, less than 6% up to a distance r_{M} of approximately 14 cm.

Overall, the diagrams of FIGS. 8 and 9 show the high degree and the particular extent of the beam homogeneity of the light beam 6 generated by the hand-lamp 1.

To generate the homogeneous light beam 6, the light-emitting body 7 has a plurality of light-emitting diodes as light-emitting means which each emit light with the same light spectrum. For example, these can be COB light-emitting diodes. However, other types are also conceivable. The light-emitting diodes preferably have a color-imparting luminescence material, e.g., a phosphor-based color-imparting luminescence material.

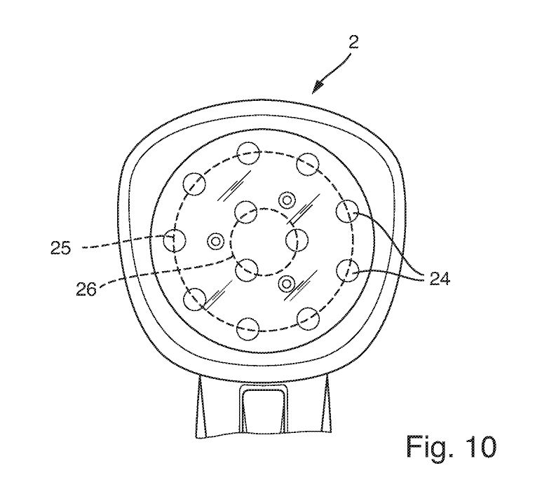

FIG. 10 shows a front view of the head part 2 of the hand-lamp 1. The front end side of the light-emitting body 7 with the light-emitting diodes 24, which are each provided with a lens, is easily visible. The light-emitting diodes 24 are arranged in a plane. Nine light-emitting diodes 24 are arranged with equal distribution on an outer circular orbit 25. Three light-emitting diodes 24 are arranged with equal distribution on an inner circular orbit 26. Owing to this arrangement of the light-emitting diodes 24, a uniform intensity distribution of the generated light beam 6 is obtained.

For example, a common lens for all light-emitting diodes can also be used instead of individual lenses for each light-emitting diode. However, it is also conceivable to use in part individual lenses and in part one lens for a plurality of light-emitting diodes.

It is to be understood that a preferred exemplary embodiment of the invention has been described merely by way of example with reference to the figures. Other designs, in particular of the light-emitting body 7, which meet the requirements of the light properties according to the invention are conceivable and are apparent for a person skilled in the art upon reading of the above statements.

It should be mentioned by way of example that a light-emitting body may be provided which, in addition to a cover plate, also has one or more further optical elements (color filters, stops, lenses), which are preferably interchangeable. The optical effects, however, can also be realized by a cover plate which additionally serves to protect the head interior.

In the case of one application, which is not shown, the hand-lamp can also be used as a stationary illumination means. For example, the hand-lamp can be attached to a stand, a holder on the paint booth ceiling or wall, a post, a handling apparatus (robot), or a similar attachment system. Instead of using an energy supply using a battery, the hand-lamp can also be connected to the power grid by way of an adapter which is connected to the hand-lamp, for example, in place of the battery.

Generally, the hand-lamp can also be connected to a control system with cables or without (e.g., via Bluetooth). The control system can be used to switch the hand-lamp on and off, for example, or to set the luminous intensity. In this case, the actuation of the on/off switch and of the setting device for the luminous intensity can be effected by remote control using suitable apparatuses. The on/off switch can also remain in the set position (on or off), wherein the luminous intensity can be regulated or controlled remotely from 0% to 100%.

It is likewise possible for sensors (e.g., color, surface or distance sensors) to be present. The settings of the hand-lamp are performed or regulated (e.g., luminous intensity depending on distance) based on the measurement data of the sensors.

A separate control system can also provide suggestions, e.g., for using color filters or other optical elements, for the luminous intensity etc., with which the hand-lamp should be provided or set to attain optimum examination results. This suggestion can also be made based on sensor data, e.g. a color detection, gloss level detection, distance detection, or surface roughness detection of the painted surface.

1. A daylight hand-lamp for examining painted surfaces, the daylight hand-lamp comprising a light-emitting body, by way of which a light beam is generable, wherein the light beam forms a beam cross-sectional area which extends perpendicularly to a beam axis at a distance of 30 cm±0.5 cm from the light-emitting body along the beam axis, wherein the beam cross-sectional area has at least one central core region with an inside diameter of at least 16 cm, wherein the light at least in the core region has a general color rendition index with a value of greater than 95, wherein the illuminance in the entire core region is greater than 5000 lx, wherein the beam cross-sectional area additionally has an inner peripheral region surrounding the core region, wherein the illuminance in the inner peripheral region decreases to at least 1000 lx, and wherein the light spectrum across the beam cross-sectional area is homogeneous at least such that, in a spectral range with a wavelength of 400 to 700 nm, a daylight deviation mean at least in the core and inner peripheral regions is less than 20%, and/or that, in a spectral range with a wavelength of 400 to 700 nm, the mean of a spectral stability factor with respect to the beam center at least in the core and inner peripheral regions is less than 10%.

2. The daylight hand-lamp of claim 1, wherein the calculation of the daylight deviation mean of a location of the beam cross-sectional area is performed such that a light spectrum that is normalized to the maximum intensity is ascertained at this location, the difference of the ascertained light spectrum with respect to a daylight spectrum that is normalized to the maximum intensity is formed, and subsequently the mean of the absolute differences over the spectral range of 400 to 700 nm is formed.

3. The daylight hand-lamp of claim 1, wherein the calculation of the mean of the spectral stability value with respect to the beam center of a location of the beam cross-sectional area is performed such that a light spectrum that is normalized to the maximum intensity is ascertained at that location, the difference of the ascertained light spectrum with respect to a light spectrum, which is normalized to the maximum intensity and was ascertained in the beam center, is formed, and subsequently the mean of the absolute differences over the spectral range of 400 to 700 nm is formed.

4. The daylight hand-lamp of claim 1, wherein the core region has an inside diameter of at least 20 cm.

5. The daylight hand-lamp of claim 1, wherein the illuminance in the core region is greater than 6000 lx.

6. The daylight hand-lamp of claim 1, wherein the daylight deviation mean in the core and inner peripheral regions is less than 18%.

7. The daylight hand-lamp of claim 1, wherein the daylight deviation mean in the core region and inner peripheral region changes by less than 6%.

8. The daylight hand-lamp of claim 1, wherein the mean of the spectral stability factor with respect to the beam center in the core and inner peripheral regions is less than 8%.

9. The daylight hand-lamp of claim 1, wherein the illuminance in the inner peripheral region decreases to 500 lx.

10. The daylight hand-lamp of claim 1, wherein the inner peripheral region is ring-shaped.

11. The daylight hand-lamp of claim 1, wherein the inner peripheral region has a width of greater than 4 cm.

12. The daylight hand-lamp of claim 1, wherein the color temperature at least in the core and inner peripheral regions is greater than 5500 K and/or less than 6500 K.

13. The daylight hand-lamp of claim 1, wherein the light-emitting body has at least one halogen lamp.

14. The daylight hand-lamp of claim 1, wherein the light-emitting body comprises one or more light-emitting diodes.

15. The daylight hand-lamp of claim 1, wherein the light-emitting body comprises a plurality of light-emitting diodes, wherein the plurality of light-emitting diodes emit light with the same light spectrum.

16. The daylight hand-lamp of claim 1, wherein the light-emitting body comprises one or more COB light-emitting diodes.

17. The daylight hand-lamp of claim 1, wherein the light-emitting body comprises one or more light-emitting diodes having a color-imparting luminescence material.

18. The daylight hand-lamp of claim 1, wherein the light-emitting body comprises a plurality of light-emitting diodes, wherein for forming the light spectrum at least one light-emitting diode is provided, which emits light with a light spectrum that differs from the light spectrum of another light-emitting diode.

19. The daylight hand-lamp of claim 1, wherein the light-emitting body comprises a plurality of light-emitting diodes, wherein the light-emitting diodes are each provided with a lens.

20. The daylight hand-lamp of claim 1, wherein the light-emitting body comprises a plurality of light-emitting diodes, wherein the plurality of light-emitting diodes are arranged in a plane, with at least some of the plurality arranged with equal distribution on an outer circular orbit and at least some of the plurality arranged with equal distribution on an inner circular orbit.

21. The daylight hand-lamp of claim 1, wherein the daylight hand-lamp is embodied in the form of a cable-free hand-lamp operated with a battery.

22. The daylight hand-lamp of claim 1, wherein the luminous intensity of the light beam which is generable by the light-emitting body is settable.
